(19) United States
(12) Patent Application Publication
(10) Pub. No.: US 2025/0318457 A1
(43) Pub. Date: Oct. 16, 2025

(54) SYSTEM AND METHOD FOR MONITORING AGRICULTURAL APPLICATION OPERATIONS

(71) Applicant: RAVEN INDUSTRIES, INC., Sioux Falls, SD (US)

(72) Inventors: Jared Ernest Kocer, Sioux Falls, SD (US); Nicholas O. Michael, Sioux Falls, SD (US)

(21) Appl. No.: 18/634,121

(22) Filed: Apr. 12, 2024

(51) Int. Cl. A01C 21/00

(52) U.S. Cl. CPC A01C 21/005

(57) ABSTRACT

A system includes an agricultural applicator that dispenses an agricultural product from an agricultural product tank via at least one dispensing assembly during an agricultural application operation. The system further includes at least one sensor for generating data indicative of a condition of the portion of the field. Additionally, the system includes a computing system that receives an input indicative of the agricultural product within the agricultural product tank. The computing system determines the condition of the portion of the field based at least in part on the data generated by the at least one sensor. Moreover, the computing system determines a desired agricultural product to dispense from the agricultural applicator based at least in part on the condition of the portion of the field. Additionally, the computing system performs a control action when the agricultural product within the agricultural product tank is inadequate for the desired agricultural product.

### FIELD OF THE INVENTION

The present disclosure relates generally to agricultural applicators and, more particularly, to systems and methods for monitoring agricultural spraying operations within a field with such agricultural applicators.

### BACKGROUND OF THE INVENTION

Agricultural applicators or sprayers apply an agricultural product (e.g., an herbicide, a fertilizer, a fungicide, a pesticide, or another product) onto plants (e.g., crops, weeds, etc.) and/or a ground surface as the sprayer is traveling proximate to a field. In some instances, the sprayer can support one or more dispensing assemblies, such as one or more nozzle assemblies and/or one or more drop tube assemblies. Each dispensing assembly has a valve configured to control the spraying of the agricultural product through an associated nozzle or drop tube onto underlying targets, which may include crops, weeds, a ground surface, and/or any other object. The sprayer may have one or more product tanks for supplying the agricultural product(s). In some instances, the agricultural product(s) may be provided to the nozzles/tubes to be dispensed “as-is,” however, in some instances, the sprayer may have an injection system that controls injection of the agricultural product(s) from the tank(s) (e.g., at the dispensing assemblies) to provide different type(s), mixture(s), and/or concentration(s) of the agricultural product(s) for spraying. However, filling and monitoring of the on-board product tanks is typically done manually, which can lead to errors.

Accordingly, systems and methods for monitoring agricultural application operations with agricultural applicators would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for monitoring agricultural application operations. The system may include an agricultural applicator comprising a frame, an agricultural product tank supported on the frame, and at least one dispensing assembly fluidly couplable to the agricultural product tank. The agricultural applicator may be configured to dispense an agricultural product from the agricultural product tank via the at least one dispensing assembly as the agricultural applicator moves across a field during an agricultural application operation. The system may further include at least one sensor having a field of view directed towards a portion of the field, where the at least one sensor may be configured to generate data indicative of a condition of the portion of the field. Additionally, the system may include a computing system. The computing system may be configured to receive an input indicative of the agricultural product within the agricultural product tank on the agricultural applicator. The computing system may further be configured to receive the data generated by the at least one sensor and determine the condition of the portion of the field based at least in part on the data generated by the at least one sensor. Moreover, the computing system may be configured to determine a desired agricultural product to dispense from the agricultural applicator based at least in part on the condition of the portion of the field. Additionally, the computing system may be configured to perform a control action associated with the agricultural applicator when the agricultural product within the agricultural product tank is inadequate for the desired agricultural product.

In another aspect, the present subject matter is directed to a method for monitoring an agricultural application operation by an agricultural applicator, where the agricultural applicator may be configured to dispense an agricultural product from an agricultural product tank via at least one dispensing assembly as the agricultural applicator moves across a field during the agricultural application operation. The method may include receiving, with a computing system, data indicative of the agricultural product within the agricultural product tank of the agricultural applicator. Further, the method may include receiving, with the computing system, data generated by at least one sensor having a field of view directed towards a portion of the field, the data being indicative of a condition of the portion of the field. The method may also include determining, with the computing system, the condition of the portion of the field based at least in part on the data generated by the at least one sensor. Moreover, the method may include determining, with the computing system, a desired agricultural product to dispense from the agricultural applicator based at least in part on the condition of the portion of the field. Additionally, the method may include performing, with the computing system, a control action associated with the agricultural applicator when the agricultural product within the agricultural product tank is inadequate for the desired agricultural product.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an agricultural applicator in accordance with aspects of the present subject matter;

FIG. 2 illustrates a side view of the agricultural sprayer in accordance with aspects of the present subject matter;

FIG. 3 is a schematic representation of a system having various vehicles in accordance with aspects of the present subject matter;

FIG. 4 illustrates a block diagram of various components of the system of FIG. 3 in accordance with aspects of the present subject matter;

FIG. 5 illustrates a flow diagram of one embodiment of a control algorithm for monitoring an agricultural application operation in accordance with aspects of the present subject matter; and

FIG. 6 illustrates a flow diagram of one embodiment of a method for monitoring an agricultural application operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used throughout this disclosure, the term “autonomous” refers to a vehicle capable of implementing at least one operation without driver input. An “operation” refers to a change in one or more of the steering, braking, acceleration/deceleration of the vehicle, actuation of a component of an implement, actuation of a component of a trailer, and/or actuation of any other component of the vehicle and/or any assembly operably coupled with the vehicle. The term “semi-autonomous” refers to a vehicle capable of implementing at least one operation that is not fully automatic but assists the operator with such operation (e.g., fully operational without a driver or driver input). As such an autonomous vehicle includes those that can operate under operator control during certain time periods and without operator control during other time periods while a semi-autonomous vehicle includes those that can operate under operator control during certain time periods and assist with operator control during other time periods.

In general, the present subject matter is directed to systems and methods for monitoring agricultural application operations, such as spraying operations, with agricultural applicators. Specifically, in several embodiments, an agricultural applicator may have one or more dispensing assemblies configured to dispense agricultural product from one or more on-board product tanks of the agricultural applicator. In accordance with aspects of the present subject matter, one or more field condition sensors may be provided, where the condition sensors are configured to generate condition data indicative of a condition of a portion of a field. Based on the condition data, a computing system may determine the condition of the portion of the field. For instance, the type of plant (e.g., weed, crop, etc.) present within the portion of the field, the moisture content of the portion of the field, and/or the like may be determined based on the condition data. It should be appreciated that, as used herein, “weed” is intended to cover any plant (e.g., non-crop) not meant to be kept within the field, including but not limited to typical weeds, grasses, bushes, and/or the like. Depending on the condition of the portion of the field, the computing system may determine a desired agricultural product to apply on the portion of the field. For example, certain weeds may require one type of weed killer (or concentrations thereof) where other types of weeds may require a different type or concentration of weed killer. Moreover, a crop treatment process may require a fertilizer or pest-control type of product, whereas a weed control process will require a weed treatment product. If the computing system determines that the agricultural product (e.g., type(s), composition(s), and/or concentration(s)) already loaded in the on-board product tank(s) of the agricultural applicator (to be applied directly and/or injected by the injection system) is inadequate for the desired agricultural product, the computing system may perform a control action associated with the agricultural applicator. In some instances, the control action may include notifying an operator that the agricultural product (e.g., type(s), composition(s), and/or concentration(s)) already loaded in the on-board product tank(s) of the agricultural applicator is inadequate for the desired agricultural product. In one or more instances, the control action may include initiating a changeover procedure, where a tendering system separate from the applicator may be used to provide the desired agricultural product to the agricultural applicator. At the very least, the conditions present within the field may be automatically monitored to ensure that the proper agricultural product is applied to the field for the conditions present, which reduces opportunities for operator error and increases potential yields.

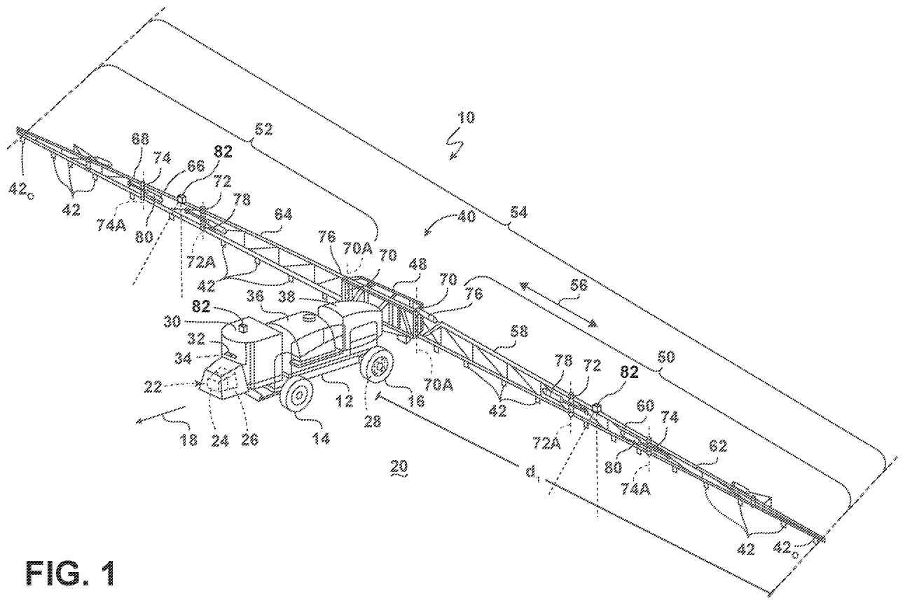

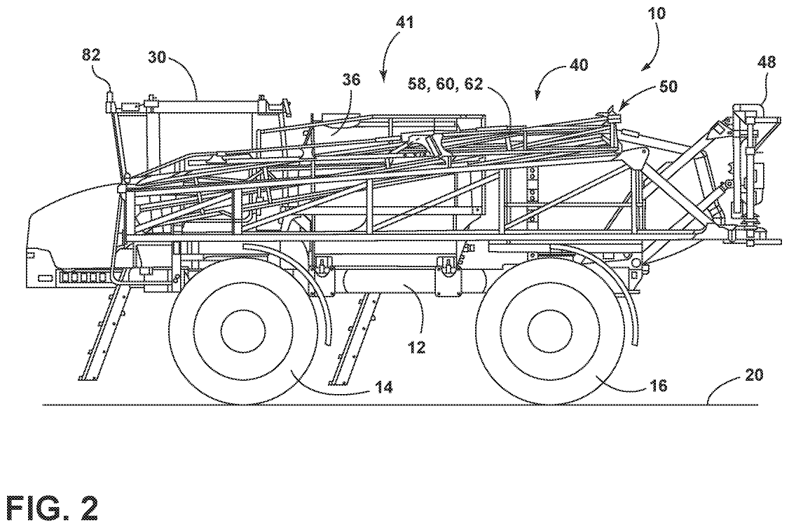

Referring now to FIGS. 1 and 2, an agricultural applicator is generally illustrated as a self-propelled agricultural sprayer 10. However, in alternative embodiments, the agricultural applicator may be configured as any other suitable type of agricultural applicator configured to perform an agricultural spraying or other product application operations, such as an applicator implement hauled or towed by a tractor or other work vehicle, an unmanned aerial vehicle (UAV) applicator, and/or the like.

In some embodiments, such as the one illustrated in FIG. 1, the agricultural sprayer 10 may include a chassis 12 configured to support or couple to a plurality of components. For example, front and rear wheels 14, 16 may be coupled to the chassis 12 and configured to support the agricultural sprayer 10 relative to a ground surface for moving the agricultural sprayer 10 in a direction of travel (e.g., as indicated by arrow 18 in FIG. 1) across a field 20. In this regard, the agricultural sprayer 10 may include a powertrain control system 22 that includes drive elements 24, such as an engine, a motor, or a hybrid engine-motor combination, a transmission system 26 configured to transmit power from the engine to the wheels 14, 16, and/or a brake system 28.

The chassis 12 may also support a cab 30, or any other form of operator's station, that houses various control or input devices (e.g., levers, pedals, control panels, buttons, and/or the like) for permitting an operator to control the operation of the sprayer 10. For instance, as shown in FIG. 1, the agricultural sprayer 10 may include a user interface 32, such as a human-machine interface (HMI), for providing messages and/or alerts to the operator and/or for allowing the operator to interface with the vehicle's computing system through one or more user-input devices 34 (e.g., levers, pedals, control panels, buttons, and/or the like) within the cab 30 and/or in any other practicable location.

The chassis 12 may also support a product system 41. The product system 41 can include one or more tanks, such as one or more product tanks 36 and/or one or more rinse tanks 38. The product tank(s) 36 is generally configured to store or hold an agricultural product, such as an herbicide(s), a fertilizer(s), a fungicide(s), a pesticide(s), dilution fluid(s) (e.g., water), or another product). The agricultural product is conveyed from the product tank(s) 36 and/or cleaning fluid is conveyed from the rinse tank(s) 38 through a product circuit including numerous plumbing components, such as interconnected pieces of tubing, for release onto the underlying field 20 (e.g., plants and/or soil) through one or more dispensing assemblies 42 mounted on the boom assembly 40 (or the sprayer 10). In the illustrated embodiment, the dispensing assemblies 42 are configured as nozzle assemblies, where each nozzle assembly 42 may include, for example, a spray nozzle and an associated valve for regulating the flow rate of the agricultural product through the nozzle (and, thus, the application rate of the nozzle assembly 42), thereby allowing the desired spray characteristics of the output or spray fan of the agricultural product expelled from the nozzle to be achieved. In some instances, each valve may be selectively activated to direct an agricultural product towards a defined target. For instance, each valve may be selectively activated to deposit a suitable herbicide towards a detected/identified weed and/or a nutrient towards a detected/identified crop. However, in some instances, the valves may be activated (e.g., continuously) to spray an entire area.

It should be appreciated that, in some embodiments, the dispensing assemblies may, in addition or alternative to the nozzle assemblies 42, include drop tube assemblies. Each drop tube assembly may generally be associated with a drop tube and a valve for regulating the flow rate of the agricultural product through the drop tube (and, thus, the application rate of the drop tube assembly). The drop tube may generally extend downwardly from a boom (described below) of the agricultural sprayer 10, closer to the field than traditional nozzles of nozzle assemblies. In some instances, the drop tube assembly may also have a spray tip proximate a lower end of the sprayer tube for varying a flow rate and/or pressure exiting the drop tube such that the desired spray characteristics of the output or spray fan of the agricultural product expelled from the drop tube may be achieved. In some instances, each valve of the drop tube assembly may be selectively activated to direct an agricultural product towards a defined target. For instance, each valve of the drop tube assembly may be selectively activated to deposit a suitable herbicide towards a detected/identified weed and/or a nutrient towards a detected/identified crop. However, in some instances, the valves of the drop tube assemblies may be activated (e.g., continuously) to spray an entire area.

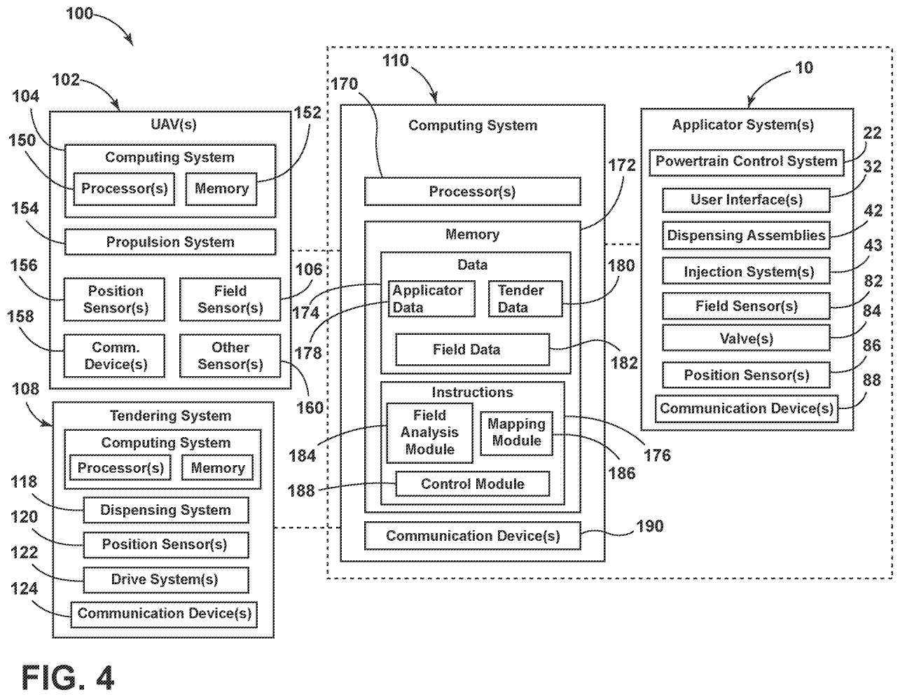

Moreover, it should be appreciated that, in some instances, the products from the product tank(s) 36 may be sprayed “as-is” and/or in some instances, an injection system 43 (FIG. 4) may be provided on the agricultural sprayer 10 that controls injection and/or mixing (e.g., at the dispensing assemblies 42) of the agricultural product(s) from the product tanks 36 to provide different type(s), mixture(s), and/or concentration(s) of the on-board agricultural product(s) for spraying. In such instances, each dispensing assembly 42 may be associated with one or more respective valves of the injection system 43 controllable to adjust the amount of agricultural product(s) delivered to the respective dispensing assembly 42 to provide different type(s), mixture(s), and/or concentration(s) of the on-board agricultural product(s) for spraying. In some instances, each dispensing assembly 42 may be associated with one or more mixing bodies of the injection system 43, where the mixing body (ies) receive and improve mixing of the agricultural product(s) from the valve(s) of the injection system 43 associated with the respective dispensing assembly 42 for dispensing.

The chassis 12 may further support a boom assembly 40 that can include a frame 48 that supports first and second boom arms 50, 52, which may be orientated in a cantilevered nature. The first and second boom arms 50, 52 are generally movable between an operative or unfolded position (FIG. 1) and an inoperative or folded position (FIG. 2). When distributing the agricultural product, the first boom arm 50 and/or the second boom arm 52 extends laterally outward from the agricultural sprayer 10 in the operative position in order to cover wide swaths of the underlying ground surface, as illustrated in FIG. 1. When extended, each boom arm 50, 52 defines an extension distance di defined between the frame 48 and an outer end portion of the boom arms 50, 52. Further, the boom arms 50, 52, when both unfolded, define a field swath 54 between respective outer dispensing assemblies 42ₒ of the first and second boom arms 50, 52 that is generally commensurate with an area of the field 20 to which the agricultural sprayer 10 covers during a pass across a field 20 to perform the agricultural operation. However, it will be appreciated that in some embodiments, a single boom arm 50, 52 may be utilized during the application operation. In such instances, the field swath 54 may be an area defined between a pair of dispensing assemblies 42 that are furthest from one another in a lateral direction 56.

To facilitate transport, each boom arm 50, 52 of the boom assembly 40 may be independently folded forwardly or rearwardly into the inoperative position, thereby reducing the overall width of the sprayer 10, or in some examples, the overall width of a towable implement when the applicator is configured to be towed behind the agricultural sprayer 10.

Each boom arm 50, 52 of the boom assembly 40 may generally include one or more boom sections. For instance, in the illustrated embodiment, the first boom arm 50 includes three boom sections, namely a first inner boom section 58, a first middle boom section 60, and a first outer boom section 62, and the second boom arm 52 similarly includes three boom sections, namely a second inner boom section 64, a second middle boom section 66, and a second outer boom section 68. In such an embodiment, the inner boom sections 58, 64 may be pivotably coupled to the frame 48 (e.g., at pivot joints 70). Similarly, the middle boom sections 60, 66 may be pivotably coupled to the respective inner boom sections 58, 64 (e.g., at pivot joints 72), while the outer boom sections 62, 68 may be pivotably coupled to the respective middle boom sections 60, 66 (e.g., at pivot joints 74). As is generally understood, pivot joints 70, 72, 74 may be configured to allow relative pivotal motion between the adjacent boom sections of each boom arm 50, 52. For example, the pivot joints 70, 72, 74 may allow for articulation of the various boom sections between a fully extended or working position (e.g., as shown in FIG. 1), in which the boom sections are unfolded along the lateral direction 56 of the boom assembly 40 to allow for the performance of an agricultural spraying operation, and a transport position (FIG. 2), in which the boom sections are folded inwardly to reduce the overall width of the boom assembly 40 along the lateral direction 56. It will be that, although each boom arm 50, 52 is shown in FIG. 1 as including three individual boom sections coupled along opposed sides of the central boom section, each boom arm 50, 52 may generally have any suitable number of boom sections.

Moreover, as shown in FIG. 1, the boom assembly 40 may include fold actuators 76, 78 coupled between the boom sections to enable pivoting or folding between the fully-extended working position and the transport position. For example, by retracting/extending the inner fold actuators 76, the inner boom sections 58, 64 may be pivoted or folded relative to the frame 48 about a pivot axis 70A defined by the pivot joints 70. Similarly, by retracting/extending the middle and outer fold actuators 78, 80, each middle and outer boom section 60, 66, 62, 68 may be pivoted or folded relative to its respective inwardly adjacent boom section 58, 64, 60, 66 about a respective pivot axis 72A, 74A. When moving to the transport position, the boom assembly 40 and fold actuators 76, 78, 80 are typically oriented such that the pivot axes 70A, 72A, 74A are generally parallel to the vertical direction and, thus, the various boom sections 58, 64, 60, 66, 62, 68 of the boom assembly 40 are configured to be folded horizontally (e.g., parallel to the lateral direction 56) about the pivot axes 70A, 72A, 74A to keep the folding height of the boom assembly 40 as low as possible for transport. However, the pivot axes 70A, 72A, 74A may be oriented along any other suitable direction.

Additionally, as will be described in greater detail below, in some instances, the agricultural sprayer 10 may include one or more field condition sensors 82 configured to generate data indicative of conditions within or at the field, where the data generated by the condition sensor(s) 82 may be used to determine whether the agricultural product loaded onto the agricultural sprayer 10 is appropriate for the conditions within the field. For instance, in some embodiments, the field condition sensor(s) 82 (hereinafter also referred to alternatingly as “field sensor(s) 82” and “condition sensor(s) 82”) may have a field of view directed towards the field and configured to generate data indicative of types of plants (e.g., crop, weeds, etc.) within the field, soil moisture, and/or the like. In some embodiments, the condition sensor(s) 82 have a field of view directed to a portion of the field in front of, or that is yet to be sprayed by, the agricultural sprayer 10 such that improper product application may be prevented earlier. However, in some embodiments, the field of view of the condition sensor(s) 82 may additionally, or alternatively, be directed toward a portion of the field below the boom assembly 40 and/or aft of the agricultural sprayer 10. It should be appreciated that while the sprayer 10 is shown as having one condition sensor 82 on each boom arm 50, 52 and one on the cab 30, the sprayer 10 may have any suitable number of condition sensors 82, such as only one condition sensor 82 (e.g., on the cab 30 alone or on one of the boom arms 50, 52), only two condition sensors 82, four condition sensors 82, or more. Moreover, in some instances, the field of view of the condition sensor(s) 82 spans across an entire swath of the agricultural sprayer 10. However, in some instances, the field of view of the condition sensor(s) 82 spans across only a portion of the swath of the agricultural sprayer 10.

In some instances, the condition sensor(s) 82 is configured as a camera(s), such as a single-spectrum camera or a multi-spectrum camera configured to capture image data, for example, in the visible light range, near-infrared spectral range, and/or infrared spectral range. Additionally, in various embodiments, the camera(s) may correspond to a single lens camera configured to capture two-dimensional image data or a stereo camera(s) having two or more lenses with a separate imaging device for each lens to allow the cameras to capture stereographic or three-dimensional image data. Alternatively, or additionally, the condition sensor(s) 82 may correspond to any other suitable image capture device(s) and/or other imaging device(s) capable of capturing “image data” or other image-like data of the field 20. For example, the condition sensor(s) 82 may correspond to or include radio detection and ranging (RADAR) sensors, light detection and ranging (LIDAR) sensors, and/or any other practicable device.

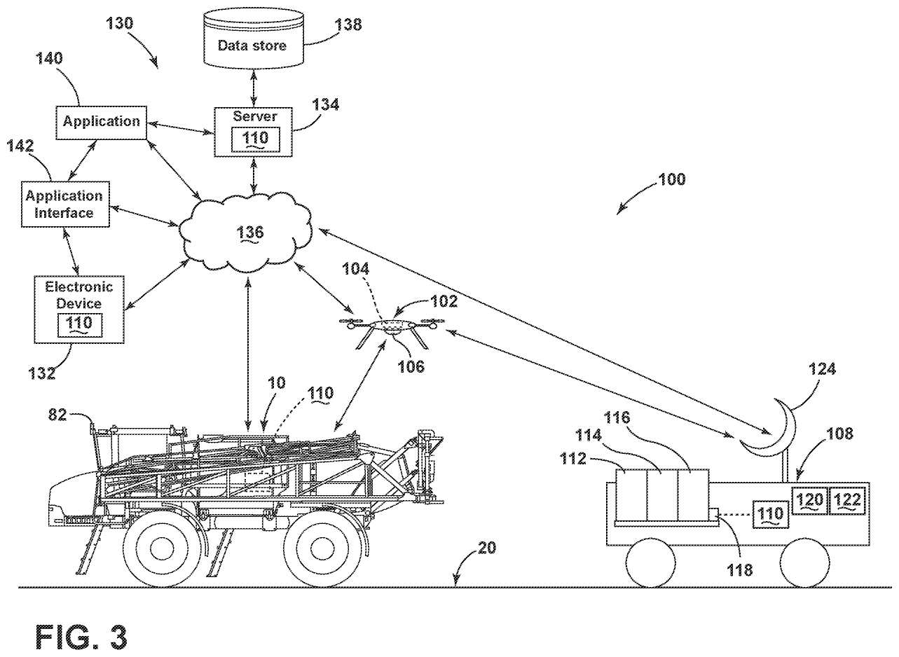

Referring now to FIG. 3, an example view of one embodiment of a system 100 for an agricultural operation is illustrated in accordance with aspects of the present subject matter. As shown in FIG. 3, the system 100 may include the agricultural sprayer 10 having the field condition sensor(s) 82 described above with reference to FIGS. 1 and 2. In some instances, the system 100 may, in some instances, include another vehicle capable of generating data indicative of field conditions at or within the field 20. For instance, in the illustrated example, the other vehicle is configured as one or more unmanned aerial vehicles (UAVs) 102 configured to be flown over the field 20 to allow field condition data to be collected via a field condition sensor(s) 106 supported on the UAV 102. It should be appreciated that the UAV 102 may generally correspond to any suitable aerial vehicle capable of unmanned flight, such as any UAV capable of controlled vertical, or nearly vertical, takeoffs and landings. For instance, in the illustrated embodiment, the UAV 102 corresponds to a quadcopter. However, in other embodiments, the UAV 102 may correspond to any other multi-rotor aerial vehicle, such as a tricopter, hexacopter, or octocopter. In still further embodiments, the UAV 102 may be a single-rotor helicopter, or a fixed wing, hybrid vertical takeoff, and landing aircraft. While the other vehicle is generally illustrated and described as a UAV, it will be appreciated that the other vehicle may additionally or alternatively be configured as a tractor, a harvester, a self-propelled windrower, a self-propelled sprayer, and/or the like. In addition, it will be appreciated that the other vehicle may be human-controlled, autonomously controlled, and/or semi-autonomously controlled without departing the scope of the present disclosure.

In several embodiments, the field condition sensor(s) 106 of the other vehicle may be configured similar to the field condition sensor(s) 82 described above with reference to FIGS. 1 and 2. For instance, the UAV 102 may be configured to make one or more passes across the field 20 to allow the field condition sensor(s) 106 to generate field condition data indicative of one or more field conditions present within the field (e.g., plants present within the field, soil moisture, and/or the like), topology of the field, obstacles within the field, and/or the like. For example, in some instances, the field condition sensor(s) 106 may generate data while the field 20 is in a pre-emergence condition (e.g., prior to the performance of a planting operation within the field 20 or following the performance of a planting operation, but prior to the emergence of planted crops), post-emergence (e.g., after emergence of planted crops and before harvesting, such as before, during, and/or after a spraying operation with the agricultural sprayer 10), and/or post-harvest (e.g., after harvesting of the crops). In instances, such as the post-emergence condition, the crop may be too tall and/or dense for the UAV(s) 102 to see some field conditions, such as weeds, when flying above the crop canopy. In such instances, the UAV(s) 102 may be flown along crop rows, under the crop canopy to detect field conditions.

In addition to the field condition sensor(s) 106, the UAV 102 may also support one or more additional components, such as an on-board computing system 104. In general, the UAV computing system 104 may be configured to control the operation of the UAV 102, such as by controlling the propulsion system 154 of the UAV 102 to cause the UAV 102 to be moved relative to the field 20. For instance, in some embodiments, the UAV computing system 104 may be configured to receive flight plan data associated with a proposed flight plan for the UAV 102, such as a flight plan selected such that the UAV 102 makes one or more passes across the field 20 in a manner that allows the field condition sensor(s) 106 to capture image data across at least a portion of the field 20. Based on such flight plan data, the UAV computing system 104 may control (e.g., automatically, semi-automatically, and/or the like) the operation of the UAV 102 such that the UAV 102 is flown across the field 20 according to the proposed flight plan to allow the desired field condition data to be collected by the field condition sensor(s) 106. However, in some instances, the UAV computing system 104 may allow for manual control of the operation of the UAV 102.

In some embodiments, the agricultural sprayer 10 may be configured to perform a treatment operation during which one or more agricultural products (e.g., fertilizers, herbicides, pesticides, and/or the like) are applied to the field 20. As indicated above, the system 100 may allow for a localized treatment prescription(s) to be generated based at least partially on the field condition data generated by the field condition sensor(s) 82, 106. In such instances, during the performance of a treatment operation, the agricultural vehicle 10 may, for example, be controlled to allow an agricultural product to be applied to specific areas within the field 20 based on the detection of a weed within that area based on the field condition data generated by the field condition sensor(s) 82, 106.

Moreover, as shown in FIG. 3, the disclosed system 100 may also include one or more tendering systems 108 separate from or remote to the agricultural sprayer 10 and/or the UAV(s) 102. In several embodiments, the tendering system(s) 108 may be configured to selectively supply agricultural product to the agricultural sprayer 10, such as to refill the product tank(s) 36 and/or cleaning fluid to the rinse tank(s) 38 on the agricultural sprayer 10. In some instances, the tendering system(s) 108 may additionally, or alternatively, be configured to selectively receive product from the agricultural sprayer 10. For such purposes, the tendering system(s) 108 may include one or more tendering tanks, such as a first tendering tank 112 and a second tendering tank 114, for dispensing agricultural product(s) (e.g., herbicide(s), fertilizer(s), fungicide(s), pesticide(s), dilution fluid(s), and/or the like), one or more receiving tanks 116 for receiving product from the agricultural sprayer 10, as well as a dispensing system 118 to adjust the flow from the tendering tank(s) 112, 114 and/or supply to/from the receiving tank(s) 116. The tendering system(s) 108 may also include a computing system 110 configured to control the operation of the tendering system(s) 108 (e.g., the operation of the dispensing system(s) 118).

In some embodiments, the tendering system(s) 108 may be supported on a movable platform, such as on a chassis on wheels. As such, the tendering system(s) 108 may include a position sensor 120, such as a satellite navigation position system (e.g. a GPS, a Galileo positioning system, a Global Navigation satellite system (GLONASS), a BeiDou Satellite Navigation and Positioning system, and/or the like), and/or a dead reckoning device, which may generate data (e.g., coordinates) indicative of an exact location of the tendering system(s) 108. In some embodiments, the tendering system(s) 108 may be self-propelled. In this regard, the tendering system(s) 108 may include any suitable drive system components 122 that allow for the trajectory, speed, and/or the like of the tendering system(s) 108 to be regulated, such as one or more power sources, one or more drive sources (e.g., an engine, a motor, or a hybrid engine-motor combination), a transmission system for transferring drive power to the wheels, one or more steering sources controllable to adjust a heading of the tendering system(s) 108, and/or a brake system. The computing system 110 of the tendering system(s) 108 may be configured to control the operation of the drive system components 122 to move the tendering system(s) 108 in a manner that supports refilling/refueling servicing of the sprayer 10. However, in some instances, the tendering system(s) 108 may additionally, or alternatively, be configured to be towed.

Additionally, the system 100 may also include one or more computing systems 130 communicatively coupled to one or more of the agricultural sprayer 10, the UAV(s) 102, and the tendering system(s) 108 to allow data to be transmitted to and from the computing system(s) 130. It should be appreciated that, in some instances, the computing system(s) 130 may be incorporated into, or form part of, a component or assembly of components of the system 100. For example, in various embodiments, the computing system(s) 130 may form part of, or be provided in operative association with, the agricultural sprayer 10. In some instances, the computing system(s) 130 additionally, or alternatively, may form part of the tendering system(s) 108. In some instances, the computing system(s) 130 additionally, or alternatively, may form part of the UAV(s) 102. For example, the computing system(s) 130 may correspond to the computing system 104 provided in operative association with the UAV(s) 102. In one instance, the computing system(s) 130 may additionally, or alternatively, form part of a base station (not shown) disposed at a fixed location, such as a farm building or central control center, which may be proximal or remote to the field 20, or a portable base station, transportable to a location within or near the field 20.

However, it should be appreciated that, in other embodiments, the computing system(s) 130 may correspond to or form part of a remote cloud-based system. For instance, the agricultural sprayer 10, the UAV(s) 102, the tendering system(s) 108, and/or an electronic device 132 (e.g., a mobile device, tablet computer, laptop computer, desktop computer, watch, virtual reality device, television, monitor, or any other computing device or another visual device) may be communicatively coupled with one another and/or one or more remote sites, such as a remote server 134 via a network/cloud 136 to provide data and/or other information therebetween. The network/cloud 136 represents one or more systems by which the agricultural sprayer 10, the UAV(s) 102, the tendering system(s) 108, and/or the electronic device 132 may communicate with the remote server 134. The network/cloud 136 may be one or more of various wired or wireless communication mechanisms, including any desired combination of wired and/or wireless communication mechanisms and any desired network topology (or topologies when multiple communication mechanisms are utilized). Exemplary communication networks 136 include wireless communication networks (e.g., using Bluetooth, IEEE 802.11, etc.), local area networks (LAN) and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g., 136 in FIG. 3). The verbal image has been formalized in the newer concept of cloud computing. The National Institute of Standards and Technology (NIST) defines cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 136.

The server 134 may be one or more computing devices, each of which may include at least one processor and at least one memory, the memory storing instructions executable by the processor, including instructions for carrying out various steps and processes. The server 134 may include or be communicatively coupled to a data store 138 for storing collected data as well as instructions for the agricultural sprayer 10, the UAV(s) 102, the tendering system(s) 108, and/or the electronic device 132 with or without intervention from a user, the agricultural sprayer 10, the UAV(s) 102, the tendering system(s) 108, and/or the electronic device 132. Moreover, the server 134 may be capable of analyzing initial or raw sensor data received from the agricultural sprayer 10, the UAV(s) 102, the tendering system(s) 108, and/or the electronic device 132, and final or post-processing data (as well as any intermediate data created during data processing). Accordingly, the instructions provided to any one or more of the agricultural sprayer 10, the UAV(s) 102, the tendering system(s) 108, and/or the electronic device 132 may be determined and generated by the server 134 and/or one or more cloud-based applications 140. In such instances, a user interface of the agricultural sprayer 10, the UAV(s) 102, the tendering system(s) 108, and/or the electronic device 132 may be a dummy device that provides various notifications based on instructions from the network/cloud 136.

With further reference to FIG. 3, the server 134 also generally implements features that may enable the agricultural sprayer 10, the UAV(s) 102, the tendering system(s) 108, and/or the electronic device 132 to communicate with cloud-based applications 140. Communications from the electronic device 132 can be directed through the network/cloud 136 to the server 134 and/or cloud-based applications 140 with or without a networking device, such as a router and/or modem. Additionally, even though communications from the cloud-based applications 140 may indicate one of the agricultural sprayer 10, the UAV(s) 102, the tendering system(s) 108, and/or the electronic device 132 as an intended recipient, such communications can also be directed to the server 134. The cloud-based applications 140 are generally any appropriate services or applications that are accessible through any part of the network/cloud 136 and may be capable of interacting with the electronic device 132.

In various examples, the agricultural sprayer 10, the UAV(s) 102, the tendering system(s) 108, and/or the electronic device 132 can be feature-rich with respect to communication capabilities, i.e. have built-in capabilities to access the network/cloud 136 and any of the cloud-based applications 140 or can be loaded with, or programmed to have, such capabilities. The agricultural sprayer 10, the UAV(s) 102, the tendering system(s) 108, and/or the electronic device 132 can also access any part of the network/cloud 136 through industry-standard wired or wireless access points, cell phone cells, or network nodes. In some examples, users can register to use the remote server 134 through the agricultural sprayer 10, the UAV(s) 102, the tendering system(s) 108, and/or the electronic device 132, which may provide access to the agricultural sprayer 10, the UAV(s) 102, the tendering system(s) 108, and/or the electronic device 132 and/or thereby allow the server 134 to communicate directly or indirectly with the agricultural sprayer 10, the UAV(s) 102, the tendering system(s) 108, and/or the electronic device 132. In various instances, the agricultural sprayer 10, the UAV(s) 102, the tendering system(s) 108, and/or the electronic device 132 may also communicate directly, or indirectly, with the agricultural sprayer 10, the UAV(s) 102, the tendering system(s) 108, and/or the electronic device 132 or one of the cloud-based applications 140 in addition to communicating with or through the server 134. According to some examples, the agricultural sprayer 10, the UAV(s) 102, the tendering system(s) 108, and/or the electronic device 132 can be preconfigured at the time of manufacture with a communication address (e.g. a URL, an IP address, etc.) for communicating with the server 134 and may or may not have the ability to upgrade or change or add to the preconfigured communication address.

Referring still to FIG. 3, when a new cloud-based application 140 is developed and introduced, the server 134 can be upgraded to be able to receive communications for the new cloud-based application 140 and to translate communications between the new protocol and the protocol used by the agricultural sprayer 10, the UAV(s) 102, the tendering system(s) 108, and/or the electronic device 132. The flexibility, scalability, and upgradeability of current server technology render the task of adding new cloud-based application protocols to the server 134 relatively quick and easy.

In several embodiments, an application interface 142 may be operably coupled with the cloud 136 and/or the application 140. The application interface 142 may be configured to receive data related to the agricultural sprayer 10, the UAV(s) 102, the tendering system(s) 108, and/or the electronic device 132. In various embodiments, one or more inputs related to the field data may be provided to the application interface 142. For example, a farmer, a vehicle user, a company, or other persons may access the application interface 142 to enter the inputs related to the field, the agricultural sprayer 10, the UAV(s) 102, the tendering system(s) 108, and/or the like. Additionally, or alternatively, such inputs may be received from the remote server 134. For example, the inputs related to the field may be received in the form of software that can include one or more objects, agents, lines of code, threads, subroutines, databases, application programming interfaces (APIs), or other suitable data structures, source code (human-readable), object code (machine-readable). In response, the system 100 may update any input/output based on the received inputs. The application interface 142 can be implemented in hardware, software, or a suitable combination of hardware and software, and which can be one or more software systems operating on a general-purpose processor platform, a digital signal processor platform, or other suitable processors.

In some examples, at various predefined periods and/or times, the agricultural sprayer 10, the UAV(s) 102, the tendering system(s) 108, and/or the electronic device 132 may communicate with the server 134 through the network/cloud 136 to obtain the stored instructions, if any exist. Upon receiving the stored instructions, the agricultural sprayer 10, the UAV(s) 102, the tendering system(s) 108, and/or the electronic device 132 may implement the instructions. In some instances, the agricultural sprayer 10, the UAV(s) 102, the tendering system(s) 108, and/or the electronic device 132 can send event-related data to the server 134 for storage in the data store 138. This collection of event-related data can be accessed by any number of users, the agricultural sprayer 10, the UAV(s) 102, the tendering system(s) 108, and/or the electronic device 132 to assist with application processes. In some instances, the electronic device 132 may also access the server 134 to obtain information related to stored events.

In various embodiments, the data used by the agricultural sprayer 10, the UAV(s) 102, the tendering system(s) 108, and/or the electronic device 132, the remote server 134, the data store 138, the application 140, the application interface 142, and/or any other component described herein for any purpose may be based on data provided by the sensors operably coupled with the agricultural sprayer 10, the UAV(s) 102, and/or the tendering system(s) 108, and/or third-party data that may be converted into comparable data that may be used independently or in conjunction with data collected from such sensors.

In various examples, the server 134 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the server 134 through the network/cloud 136 and may be used to generate a predictive evaluation of the field conditions. In some instances, the machine learning engine may allow for changes to a map of the field conditions to be updated without human intervention.

As will be described below in greater detail, in various embodiments, based on the data generated by the field condition sensor(s) 82, 106 and/or any other suitable data, the system 100 may be configured to identify one or more field conditions within the field 20. For instance, the system 100 may determine a type of plant (e.g., crop and/or weed) and/or moisture content present at different locations within the field 20 based on the data generated by the field condition sensor(s) 82, 106. Once such field conditions are identified, the system 100 may be configured to determine an appropriate or desired type of agricultural product for the field conditions identified. Thereafter, the system 100 may be configured to determine whether the current agricultural product loaded on the agricultural sprayer 10 suits the desired agricultural product. If the system 100 determines that the current agricultural product loaded on the agricultural sprayer 10 does not suit the desired agricultural product, the system 100 may perform a control action associated with the agricultural sprayer 10 and/or the tendering system 108. For instance, the control action may include notifying an operator that the detected field conditions do not match expected conditions and/or that the current agricultural product loaded on the agricultural sprayer 10 does not match or suit the desired agricultural product for the present field conditions, and/or may include performing a changeover procedure with the agricultural sprayer 10 and the tendering system 108.

Referring now to FIG. 4, a schematic view of components of the system 100 of FIG. 3 is illustrated in accordance with aspects of the present subject matter. Particularly, the system 100 is described in FIG. 4 with reference to one or more agricultural applicators (e.g., the agricultural sprayer(s) 10), one or more of the UAVs 102, and one or more of the tendering systems 108 from FIG. 3. It should be appreciated, however, that, in other embodiments, the disclosed system 100 may have any other suitable system configuration or architecture and/or may incorporate any other suitable components and/or combination of components that generally allow the system 100 to function as described herein.

As described above, the UAV(s) 102 of the system 100 may include or be configured to support various components, such as the field condition sensor(s) 106, the propulsion system 154, one or more position sensor(s) 156, one or more communications devices 158, and/or one or more other devices 160. It should be appreciated that the position sensor(s) 156 may be configured similar to the position sensor(s) 120 of the tendering system(s) 108, with the position sensor(s) 156 of the UAV(s) 102 being configured to generate data (e.g., coordinates) indicative of an exact location of the UAV(s) 102 (e.g., relative to the field 20).

Additionally, as indicated above, the UAV 102 may also include the computing system 104. In general, the UAV computing system 104 may correspond to any suitable processor-based device(s), such as a computing device or any combination of computing devices. Thus, in several embodiments, the UAV computing system 104 may include one or more processor(s) 150 and associated memory device(s) 152 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 152 of the UAV computing system 104 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 152 may generally be configured to store suitable computer-readable instructions that, when implemented by the processor(s) 150, configure the UAV computing system 104 to perform various computer-implemented functions. It should be appreciated that the UAV computing system 104 may also include various other suitable components, such as a communications circuit or module, a network interface, one or more input/output channels, a data/control bus, and/or the like.

In several embodiments, as indicated above, the UAV computing system 104 may be configured to control (e.g., automatically, semi-automatically, and/or the like) the propulsion system 154 in a manner that allows the UAV 102 to be flown across a field 20 according to a predetermined or desired flight plan and/or based on manual, operator control. In this regard, the propulsion system 154 may include any suitable components that allow for the trajectory, speed, and/or altitude of the UAV 102 to be regulated, such as one or more power sources (e.g., one or more batteries), one or more drive sources (e.g., one or more motors and/or engines), and one or more lift/steering sources (e.g., propellers, blades, wings, rotors, and/or the like). The UAV computing system 104 may also monitor the location of the UAV 102 as a pass is being made across the field 20 such that the sensor data generated by the field condition sensor(s) 106 may be geo-located within the field 20. For instance, in various embodiments, the location coordinates derived from the position sensor(s) 156 and the sensor data generated by the field condition sensor(s) 106 may both be time-stamped. In such an embodiment, the time-stamped data may allow the field condition data to be matched or correlated to a corresponding set of location coordinates received or derived from the position sensor(s) 156, thereby allowing a field map to be generated that locates various objects (e.g., plants, landmarks, obstacles, etc.) and/or field conditions within the field 20.

The other devices 160 of the UAV 102 may include one or more inertial measurement units for monitoring the orientation of the UAV 102 and/or one or more altitude sensors for monitoring the pose of the UAV 102 relative to the ground. As used herein, “pose” includes the position and orientation of an object, such as the position and orientation of a vehicle, in some reference frame. Moreover, the communications device(s) 158 of the UAV 102 is configured to allow the UAV computing system 104 to be communicatively coupled to one or more other system components. The communications device(s) 158 may, for example, be configured as a wireless communications device (e.g., an antenna or transceiver) to allow for the transmission of wireless communications between the UAV computing system 104 and one or more other system components.

Similarly, the tendering system(s) 108 of the system 100 may include or be configured to support various components, such as the dispensing system 118, the position sensor(s) 120, the drive system(s) 122, and one or more communications device(s) 124. Moreover, as indicated above, the tendering system(s) 108 may also include a computing system 110. In general, the tendering computing system 110 may correspond to any suitable processor-based device(s), similar to the UAV computing system 104, such as a computing device or any combination of computing devices. In this regard, in several embodiments, the tendering computing system 110 may include one or more processor(s) and associated memory device(s) configured to perform a variety of computer-implemented functions. The communications device(s) 124 of the tendering system(s) 108 is configured to allow the tendering computing system 110 to be communicatively coupled to one or more other system components. The communications device(s) 124 may, for example, similar to the communications device(s) 158, be configured as a wireless communications device (e.g., an antenna or transceiver) to allow for the transmission of wireless communications between the tendering computing system 110 and one or more other system components.

In several embodiments, as indicated above, the tendering computing system 110 may be configured to control the tendering system 108 to support refilling/changeover servicing of the agricultural sprayer 10. For instance, the tendering computing system 110 may control the operation of the dispensing system 118 of the tendering system 108 to adjust the flow from the tendering tank(s) 112, 114 and/or supply to/from the receiving tank(s) 116. The dispensing system 118 may be controlled to provide individual products (and/or particular concentrations thereof) from the tanks 112, 114, to provide a mixture(s) of different products from the tanks 112, 114 to the product tank(s) 36, and/or the like. Similarly, the tendering computing system 110 may control the operation of the drive system(s) 122 of the tendering system 108 to move the tendering system 108 to the agricultural sprayer 10 (e.g., automatically, semi-automatically, and/or based on manual operator inputs). Moreover, as will be described below in greater detail, the memory of the tendering computing system 110 may be configured to store information about the tendering system 108, such as the product (e.g., type and/or concentration) within the tanks(s) 112, 114, 116, the location of the tendering system 108 (e.g., based on the data from the position sensor(s) 120), and/or the like.

The agricultural sprayer 10 of the system 100, as described above, may include or be configured to support various components, such as the powertrain control system(s) 22, the user interface(s) 32, one or more application systems (e.g., including the product tank(s) 36, the rinse tank(s) 38, the plumbing components, the dispensing assembly(ies) 42, additional valve(s) 84 for recirculation and/or cleanout, etc.), the field condition sensor(s) 82, one or more position sensor(s) 86, and one or more communication devices 88. It should be appreciated that the position sensor(s) 86 may be configured similar to the position sensor(s) 120, 156, with the position sensor(s) 86 being configured to generate data (e.g., coordinates) indicative of an exact location of the agricultural sprayer 10 (e.g., within the field 20). The communications device(s) 88 may, for example, similar to the communications device(s) 124, 158, be configured as a wireless communications device (e.g., an antenna or transceiver) to allow for the transmission of wireless communications between the agricultural sprayer 10 and one or more other system components.

The system 100 may also include another computing system, such as one or more of the computing system(s) 110 described with reference to FIG. 3, where the other computing system 110 may be configured to be in communication with one or more of the components of the sprayer 10, the UAV(s) 102, and/or the tendering system(s) 108 to allow data to be transferred between the computing system 110 and the sprayer 10, the UAV(s) 102, and/or the tendering system(s) 108. As indicated above, the one or more computing systems 110 may correspond to a stand-alone component or may be incorporated into or form part of a separate component or assembly of components. For example, in FIG. 4, the other computing system(s) 110 is illustrated as being incorporated into or forming part of the agricultural sprayer 10, as such, such other computing system 110 will be referred to as the “applicator computing system 100”. However, in addition, or as an alternative thereto, such other computing system(s) 110 may correspond to a component of the tendering system(s) 108, the UAV(s) 102, or may be remote from the tendering system(s) 108, the UAV(s) 102, and/or the agricultural sprayer 10.

The applicator computing system(s) 110 may be configured as any suitable processor-based device(s), such as a computing device or any combination of computing devices. As such, the applicator computing system(s) 110 may include one or more processor(s) 170 and associated memory device(s) 172 configured to perform a variety of computer-implemented functions. The memory device(s) 172 may generally be configured to store data 174 and suitable computer-readable instructions 176 that, when implemented by the processor(s) 170, configure the applicator computing system(s) 110 to perform various computer-implemented functions. It should be appreciated that the applicator computing system(s) 110 may also include various other suitable components, such as a communications circuit or module, a network interface, one or more input/output channels, a data/control bus, and/or the like. For example, the applicator computing system 110 may further include a communications device(s) 190, similar to the communications device(s) 88, 124, 158, configured as a wireless communications device (e.g., an antenna or transceiver) to allow for the transmission of wireless communications between the applicator computing system 110 and one or more other system components.

In various embodiments, the data 174 of the memory device(s) 172 of the applicator computing system(s) 110 may include one or more databases for storing information. For instance, as shown in FIG. 4, the memory device(s) 172 may include an applicator database 178 for storing data related to the agricultural sprayer 10, such as data indicative of the configuration of the agricultural sprayer 10, the agricultural product(s) and/or cleaning fluid(s) loaded onto the agricultural sprayer 10 (e.g., within the tank(s) 36, 38), the position of the agricultural sprayer 10 (e.g., based on data generated by the position sensor(s) 86), and/or the like. It should be appreciated that the data indicative of the configuration of the agricultural sprayer 10 and/or the product(s) loaded onto the agricultural sprayer 10 (e.g., within the tank(s) 36, 38) may be input manually or may be otherwise input into the applicator database. For instance, in some embodiments, a composition sensor may be configured to generate data indicative of the type(s), mixture(s), and/or concentration(s) of the agricultural product loaded onto the agricultural sprayer 10. In other instances, a system (e.g., the tendering system(s) 108) tendering the agricultural product onto the sprayer 10 may provide the data indicative of the agricultural product loaded onto the sprayer 10.

Moreover, the memory device(s) 172 may include a tender database 180 for storing data indicative of the configuration of tendering system(s) 108, the product(s) loaded onto the tendering system(s) 108 (e.g., within the tank(s) 112, 114, 116), the position of the tendering system(s) 108, and/or the like. It should similarly be appreciated that the data indicative of the configuration of tendering system(s) 108 and/or the agricultural product loaded onto the tendering system(s) 108 (e.g., within the tank(s) 112, 114, 116) may be input manually or may be otherwise input into the tender database 180. For instance, in some embodiments, a composition sensor may be configured to generate data indicative of the type(s), mixture(s), and/or concentration(s) of the product(s) loaded onto the tendering system(s) 108. In other instances, a system tendering the agricultural product onto the tendering system(s) 108 may provide the data indicative of the product(s) loaded onto the tendering system(s) 108.

Additionally, the memory device(s) 172 may include a field database 182 for storing data indicative of the field, such as the field condition data generated by the field condition sensor(s) 82, 106, and/or additional data, such as field coordinates, and/or the like. In some instances, the additional data may be input manually or may be otherwise input into the field database 182.

Referring still to FIG. 4, in several embodiments, the instructions 176 stored within the memory device(s) 172 of the applicator computing system(s) 110 may be executed by the processor(s) 170 to implement a field analysis module 184. In general, the field analysis module 184 may be configured to analyze the field data from the sensor(s) 82, 106 to allow the applicator computing system(s) 110 to identify one or more field conditions within the field 20, such as plants (e.g., crops, weeds, and/or the like) within the field 20, moisture content within the field 20, and/or the like, in addition to other features that may be present within the field 20, such as obstacles, landmarks, and/or the like. For instance, in several embodiments, the field analysis module 184 may be configured to analyze/process the field data 182 to detect/identify the type of various plants in the field 20. In this regard, the applicator computing system 110 may include any suitable image processing algorithms stored within its memory 172 or may otherwise use any suitable image processing techniques to determine, for example, the type of various plants in the field 20 based on the field data 182. For instance, in some embodiments, the applicator computing system 110 may be able to directly distinguish between weeds and emerging/standing crops and identify their types. Additionally, or alternatively, in some embodiments, the computing system 110 may be configured to distinguish between weeds and emerging/standing crops by identifying crop rows of emerging/standing crops and then inferring that plants positioned between adjacent crop rows are weeds.

Moreover, the instructions 176 stored within the memory device(s) 172 of the applicator computing system 110 may be executed by the processor(s) 170 to implement a mapping module 186 that is configured to generate one or more maps of the field 20 based on the field data 182. It should be appreciated that, as used herein, a “map” may generally correspond to any suitable dataset that correlates data to various locations within a field 20. Thus, for example, a map may simply correspond to a data table that correlates the field data 182 to various locations within the field 20 or may correspond to a more complex data structure, such as a geospatial numerical model that can be used to identify various objects and/or topology from the field data 182 and determine a position of each object within the field 20, which may, for instance, then be used to generate a graphically displayed map or visual indicator. For instance, the field condition data generated by the field condition sensor(s) 82, 106 may be matched or correlated to a corresponding set of location coordinates received or derived from the position sensor(s) 86, 156, thereby allowing a field map to be generated that locates various field conditions, obstacles, landmarks, topology, and/or the like (e.g., as identified by the field analysis module 184) within the field 20. Such field map may also indicate the location of field conditions relative to plants, such as below the crop canopy, between crop rows, and/or the like.

Referring still to FIG. 4, in some embodiments, the instructions 176 stored within the memory 172 of the applicator computing system 110 may also be executed by the processor(s) 170 to implement a control module 188. In general, the control module 188 may be configured to electronically control the operation of one or more components of the system 100 (e.g., of the applicator system(s) 10 and/or the tendering system(s) 108). For instance, the control module 188 may be configured to control an operation of the applicator system (e.g., the sprayer 10) during the performance of an agricultural application operation (e.g., a spraying operation). For example, the control module 188 may be configured to control an operation of the applicator system 10 to spray within the field, such as based on operator inputs and/or based on a prescription map for the agricultural application operation. Further, the control module 188 may be configured to recommend and/or automatically control which components (e.g., nozzle assemblies and/or drop down assemblies) of the system 100 to use to perform the application operation based on the field condition data, the prescription map, and/or the type of application operation being performed. For example, when weeds are detected under the crop canopy, the control module 188 may recommend (e.g., by controlling the user interface(s) 32) and/or automatically control the valves associated with drop hose assemblies instead of valves associated with the nozzle assemblies to spray weeds with herbicide under the canopy of the crop.

Moreover, the control module 188 may be configured to control one or more components of the system 100 based at least in part on the field conditions detected within the field 20. For instance, the control module 188 may be configured to control one or more components of the system 100 (e.g., the dispensing assembly (ies) 42 of the sprayer 10 and the injection system 43) to dispense the agricultural product from the agricultural product tank(s) 36 within the portion of the field when the agricultural product(s) within the agricultural product tank(s) 36 (to be applied directly from the agricultural product tank(s) 36 as-is and/or to be provided for application via injection of the agricultural product(s) from the agricultural product tank(s) 36 by the injection system 43) corresponds to the desired agricultural product. However, when the agricultural product within the agricultural product tank(s) 36 does not correspond to the desired agricultural product, such as if the on-board agricultural product(s) cannot be directly applied and/or the injection system 43 cannot be controlled to provide the desired agricultural product based on the agricultural product(s) within the agricultural product tank(s) 36, the control module 188 may be configured to perform a control action.

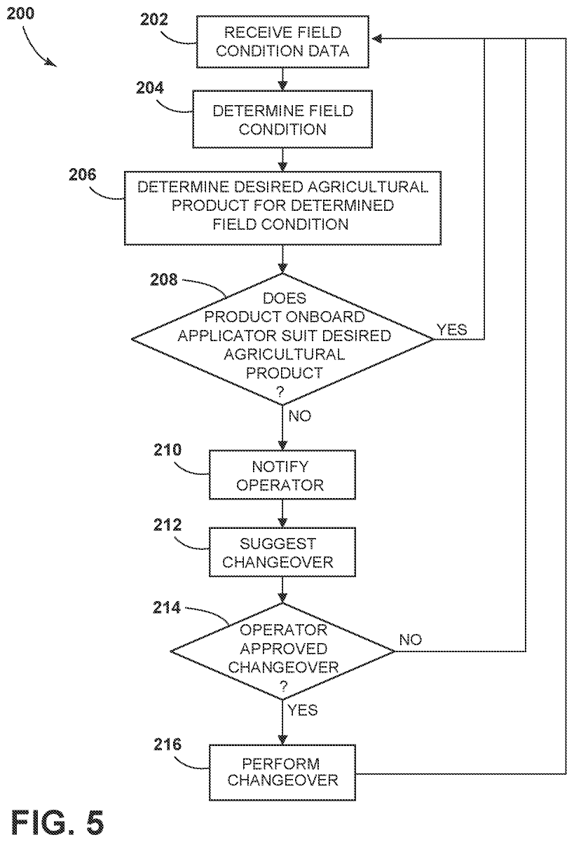

For instance, referring now to FIG. 5, an example of a flow diagram of one embodiment of a control algorithm 200 for monitoring agricultural product for an agricultural application operation is illustrated in accordance with aspects of the present subject matter. In general, the control algorithm 200 will be described herein as being implemented by the applicator computing system 110 of the system 100 described above with reference to FIG. 4. However, it should be appreciated that the various processes described below may alternatively, or additionally, be implemented by another computing system(s) (e.g., the computing system(s) 110 of the tendering system(s) 108) or combination of computing system(s). In addition, although FIG. 5 depicts control steps or functions performed in a particular order for purposes of illustration, the management routines discussed herein are not limited to any particular order or arrangement. One skilled in the art, using the disclosures provided herein, will appreciate that the various steps or functions of the algorithms disclosed herein can be omitted, rearranged, combined, and/or adapted in various ways without deviating from the scope of the present disclosure.

As shown at (202) in FIG. 5, the computing system 110 may receive field condition data. For instance, as described above with reference to FIG. 4, the computing system 110 may receive (directly or indirectly) the field condition data 182 generated by the field condition sensor(s) 82, 106. Referring still to FIG. 5, at (204), the computing system 110 may determine one or more field conditions present within the field 20. For instance, as described above with reference to FIG. 4, the field analysis module 184 may determine one or more field conditions present within the field based at least in part on the field condition data 182. For example, the field analysis module 184 may determine the types of plants (e.g., crops, weeds, and/or the like) present within the field 20, moisture content present within the field, and/or the like. Alternatively, or additionally, the computing system 110 may identify the field conditions present from a prescription map or established vegetation index.

Thereafter, at (206) in FIG. 5, the computing system 110 may determine a needed or desired agricultural product(s) to be applied for the determined field condition(s). For instance, the computing system 110 may determine one or more desired agricultural products (e.g., type(s), mixture(s), and/or concentration(s) of agricultural product(s)) to be applied for the determined field condition(s) based at least in part on a table correlating different field conditions with different agricultural products, where the desired agricultural product within the table associated with the field condition(s) determined within the field 20 may be identified. It should be appreciated that, in some instances, the table may be stored in the memory 172 (FIG. 4) of the computing system 110 or may be otherwise accessible by the computing system 110.

After determining the desired agricultural product(s) to be applied for the determined field condition(s), at (208), the computing system 110 may determine whether the product onboard the applicator (e.g., sprayer 10) suits the desired agricultural product(s). For instance, the computing system 110 may compare the agricultural product(s) (e.g., the type(s), mixture(s), and/or concentration(s) of agricultural product(s)) known to be loaded onto the sprayer 10 (e.g., within the product tank(s) 36) to the desired agricultural product(s). As indicated above, data indicative of the agricultural product(s) loaded onto the sprayer 10 may be provided to the applicator database 178. If, at (208), the product onboard the sprayer 10 suits the desired agricultural product(s) (e.g., type(s), mixture(s), and/or concentration(s)), then the computing system 110 may return to (202) and continue monitoring the field condition data. However, if, at (208), the product onboard the sprayer 10 does not suit the desired agricultural product(s) (e.g., type(s), mixture(s), and/or concentration(s)), such as if the on-board agricultural product(s) cannot be directly applied and/or the correct agricultural product cannot be provided by controlling the injection system 43 to use the on-board agricultural product(s), then the computing system 110 may perform a control action.

For instance, the control action may include the computing system 110, at (210), indicating to an operator that the product(s) onboard the sprayer 10 does not suit the desired agricultural product(s) (e.g., type(s), mixture(s), and/or concentration(s)) for direct application and/or injection by the injection system 43. For example, in some instances, the computing system 110 may notify an operator that the detected conditions within the field do not match expected conditions. In one or more instances, the computing system 110 may provide images showing the detected conditions (e.g., from the field data 182). In some instances, the computing system 110 may additionally, or alternatively, notify an operator that the product(s) onboard the sprayer 10 does not suit the desired agricultural product(s). In some instances, the computing system 110 controls the operation of a user interface associated with the system 100 (e.g., user interface 32 associated with the sprayer(s) 10, a user interface associated with the tendering system(s) 108, a user interface associated with a base station, and/or the like) to provide such notification(s). In response, in some instances, the operator may decide and provide an input on whether the detected conditions within the field match expected conditions, decide and provide an input on whether a changeover procedure should occur, and/or decide and provide an input on what agricultural products need to be loaded for such changeover.

In some instances, the computing system 110 may additionally, or alternatively, at (212), suggest a changeover procedure to an operator to load the desired agricultural product(s) (or products for providing the desired agricultural product(s)) onto the sprayer 10. In one or more instances, the computing system 110 controls the operation of a user interface associated with the system 100 (e.g., user interface 32 associated with the sprayer(s) 10, a user interface associated with the tendering system(s) 108, a user interface associated with a base station, and/or the like) to provide such suggestion. If, at (214), an operator does not approve the changeover (e.g., no input indicative of accepting the request is received via the user interface 32 or another user interface associated with the system 100), the computing system 110 may return to (202) and continue monitoring the field condition data. However, if at (214), an operator approves the changeover (e.g., an input indicative of accepting the request is received via the user interface 32 or another user interface associated with the system 100), the computing system 110 may proceed to step 216 and perform the changeover procedure. In some instances, however, it should be appreciated that the computing system 110 may automatically begin the changeover procedure upon determining, at (208), that the product onboard the sprayer 10 does not match the desired agricultural product(s) in addition, or in alternative, to notifying the operator at (210) and/or suggesting the changeover at (212).

The changeover procedure at (216) may include automatically routing the sprayer(s) 10 and/or the tendering system(s) 108 such that the sprayer(s) 10 may be filled with the correct product by the tendering system(s) 108. In some instances, the computing system 110 may automatically control the operation of the powertrain control system(s) 22 of the sprayer 10 and/or the drive system(s) 122 of the tendering system(s) 108 to (autonomously) bring the sprayer 10 and tendering system(s) 108 within range of each other for filling the sprayer(s) 10. However, in some instances, the computing system 110 may additionally, or alternatively, automatically route or re-route a guidance path for the sprayer(s) 10 and/or a guidance path for the tendering system(s) 108 for guiding semi-autonomous or manual navigation of the sprayer 10 and/or the tendering system(s) 108. The changeover procedure may also include automatically control or route the tendering system(s) 108 to a refill area for loading the necessary products for the changeover procedure onto the tendering system(s) 108 if the necessary products for the changeover procedure are not already loaded on the tendering system(s) 108 (e.g., in the tendering tanks 112, 114). Alternatively, or additionally, the changeover procedure may include notifying an operator if the necessary products for the changeover procedure are not already loaded on the tendering system(s) 108 (e.g., in the tendering tanks 112, 114) and request that the necessary products be brought to the tendering system(s) 108 and/or that the tendering system(s) 108 be brought to be re-filled with the necessary products.

It should be appreciated that the changeover procedure may account for the particular treatment process being performed. For instance, if a first (e.g., fertilizer, fungicide, pesticide, herbicide, or the like) treatment process is being performed using the on-board agricultural product(s) and field conditions associated with a different treatment process are detected that cannot be treated using the on-board agricultural product(s), the changeover procedure may not be implemented until after the first treatment process is complete. For example, if a fertilizer treatment operation for fertilizing crops is being performed and weeds are detected in the field that cannot be treated based on the loaded agricultural product(s), the changeover procedure may not be implemented until after the fertilizer treatment operation is complete.

When the agricultural product tank(s) 36 is determined to contain an incorrect agricultural product(s) (e.g., type, mixture, and/or concentration) at (208), the changeover procedure at (216) may further include evacuating the agricultural product from the agricultural product tank(s) 36 before the tendering system 108 is controlled to fill the agricultural product tank(s) 36 of the sprayer 10 with the desired agricultural product (for direct application and/or injection by the injection system 43). For instance, the computing system 110 may instruct or control the operation of the plumbing components (e.g., dispensing assembly (ies) 42, the injection system 43, and/or the valve(s) 84) of the sprayer(s) 10 to evacuate of the agricultural product from the agricultural product tank(s) 36 and boom. In some instances, the plumbing components of the sprayer(s) 10 are connectable to the tendering system 108 (e.g., a flanged coupling, a quick interconnect coupling, a threaded coupling, and/or the like) such that the tendering system(s) 108 receives the evacuated product from the agricultural sprayer(s) 10. For instance, the plumbing components of the sprayer(s) 10 may be connectable to the tendering system 108 such that the receiving tank(s) 116 on the tendering system 108 may receive the evacuated product from the agricultural sprayer(s) 10. In such instances, the plumbing components (e.g., dispensing assembly (ies) 42, valve(s) 84, and/or pump(s)) of the sprayer(s) 10 may be controlled for evacuation of the agricultural product (and any cleaning product within the boom) from the agricultural product tank(s) 36 of the sprayer(s) 10 and the dispensing system 118 of the tendering system 108 may be controlled to direct the evacuated agricultural product into the receiving tank(s) 116 on the tendering system 108. However, it should be appreciated that, in some instances, the agricultural product evacuated from the agricultural product tank(s) 36 of the sprayer(s) 10 may additionally, or alternatively, be dispensed onto a rinse out area of a field and/or dispensed into a receiving tank on the sprayer(s) 10.

When the agricultural product tank(s) 36 is determined to contain an incorrect agricultural product(s) (e.g., type, mixture, and/or concentration) at (208), the changeover procedure at (216) may further include a cleaning procedure before the tendering system(s) 108 fills the agricultural product tank(s) 36 with the desired agricultural product. For instance, the computing system 110 may instruct or control supply of a cleaning fluid from a cleaning fluid tank (e.g., from the rinse tank(s) 38 on the sprayer 10 and/or one of the tendering tank(s) 112, 114 of the tendering system(s) 108) through the agricultural product tank(s) 36 and/or plumbing components of the sprayer 10 before the tendering system 108 is controlled to fill the agricultural product tank(s) 36 of the sprayer 10 with the desired agricultural product(s). In such instance, the plumbing components of the sprayer 10 (e.g., the dispensing assembly (ies) 42, the injection system 43, additional valve(s) 84, pump(s), and/or the like) may be controlled to selectively recirculate the cleaning fluid through the boom assembly and/or the tank(s) 36 then evacuate the cleaning fluid and remaining incorrect agricultural product(s) from the sprayer 10. In some instances, a composition sensor may be used to determine when the fluid evacuated from the sprayer 10 during the cleaning process contains less than a threshold amount of the incorrect agricultural product(s). The cleaning fluid may be any suitable cleaning fluid, such as water, neutralizing agents for the incorrect agricultural product(s), dilution fluids, and/or the like.

In some instances, it should be appreciated that the changeover procedure may not be a complete changeover, where the current agricultural product(s) are completely removed from the product tank(s) 36 on the sprayer. For instance, in some embodiments, the changeover procedure may include providing an additional chemical to the agricultural product tank(s) 36 to change the mixture(s) and/or concentration(s) within the product tank(s) 36.

Once the sprayer 10 is ready to receive the desired agricultural product, such as after the evacuation procedure and/or cleaning procedure, the tendering system(s) 108 may be controlled to fill the agricultural product tank(s) 36 of the sprayer(s) 10 with the desired agricultural product or products to create the desired agricultural product. In some instances, the computing system 110 is configured to control the tendering system(s) 108 (e.g., the dispensing system 118) to dispense the desired agricultural product(s) or products to create the desired agricultural product. The dispensing system 118 may be controlled to provide individual products (and/or particular concentrations thereof) from the tanks 112, 114 to individual product tanks 36 on the sprayer(s) 10, to provide a mixture(s) of different products from the tanks 112, 114 to the product tank(s) 36, and/or the like. In some instances, the computing system 110 is configured to directly, automatically control the tendering system(s) 108. However, in some instances, the computing system 110 may be configured to additionally, or alternatively, allow for indirect control of the tendering system(s) 108, such as by allowing user input at the computing system 110 of instructions for controlling the dispensing system 118.

Once the changeover procedure is complete, the computing system 110 may control the agricultural sprayer 10 to perform a spraying operation to dispense the desired agricultural product(s) based at least in part on the detected field conditions.

It is again noted that, while the computing system 110 of the applicator system 10 is discussed as performing the control algorithm 200 of FIG. 5, one or more of the steps of the control algorithm 200 may instead, or additionally, be performed by another computing system of the system 100 (FIG. 4). For instance, the computing system(s) 110 of the tendering system(s) 108 may instead, or additionally, be configured to perform one or more of the steps of the control algorithm 200.

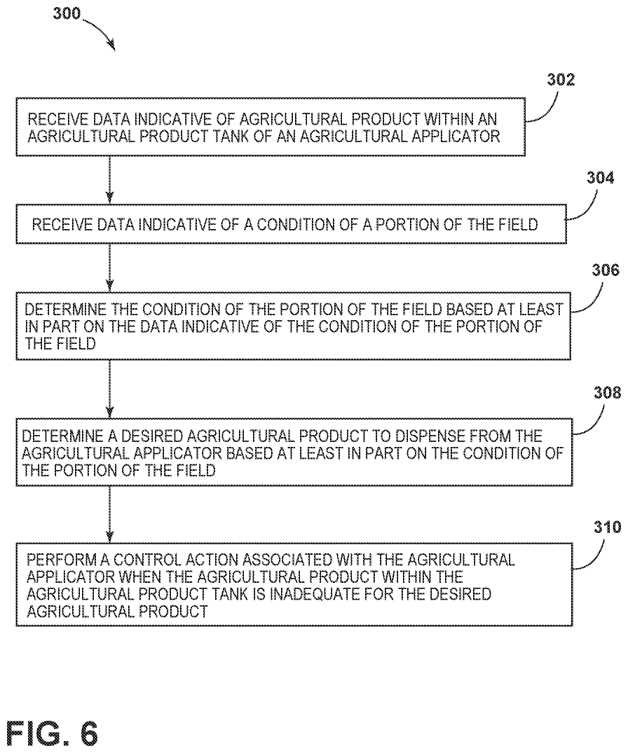

Referring now to FIG. 6, a flow diagram of some embodiments of a method 300 for monitoring an agricultural application operation is illustrated in accordance with aspects of the present subject matter. In general, the method 300 will be described herein with reference to the system 100 described above with reference to FIGS. 1-5. However, it will be appreciated by those of ordinary skill in the art that the disclosed method 300 may generally be utilized with any suitable system having any suitable agricultural vehicles and/or may be utilized in connection with a system having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (302), the method 300 may include receiving data indicative of agricultural product within an agricultural product tank of an agricultural applicator. For instance, as described above, the computing system 110 may receive data indicative of agricultural product within the agricultural product tank(s) 36 of the agricultural applicator (e.g., sprayer 10). For example, in some instances, the computing system 110 may receive a user input(s) indicative of the agricultural product within the agricultural product tank(s) 36. In one or more instances, the computing system 110 may additionally, or alternatively, receive the data indicative of agricultural product within the agricultural product tank(s) 36 from one or more composition sensor(s) and/or one or more tendering system(s) 108 that loaded the agricultural product onto the sprayer 10.

Further, at (304), the method 300 may include receiving data indicative of a condition of a portion of the field. For example, as discussed above, the computing system 110 may receive data generated by the field condition sensor(s) 82, 106 indicative of the field condition(s) of a portion of the field 20 within the field of view of the field condition sensor(s) 82, 106. In some embodiments, the field condition(s) includes one or more of types of plants present within the portion of the field 20 and/or moisture content present within the portion of the field 20.

At (306), the method 300 may further include determining the condition of the portion of the field based at least in part on the data indicative of the condition of the portion of the field. For instance, as discussed above, the computing system 110 may determine the condition of the portion of the field based at least in part on the data indicative of the condition of the portion of the field (e.g., the data generated by the field condition sensor(s) 82, 106). For instance, the computing system 110 may use any suitable data processing technique(s) (e.g., image processing technique(s), numerical processing technique(s), and/or the like) on the data generated by the field condition sensor(s) 82, 106 to determine the condition (e.g., types of plants present, moisture content, and/or the like) of the portion of the field.

Moreover, at (308), the method 300 may include determining a desired agricultural product to dispense from the agricultural applicator based at least in part on the condition of the portion of the field. For instance, as described above, the computing system 110 may determine a desired agricultural product to dispense from the agricultural applicator (e.g., sprayer 10) based at least in part on the condition of the portion of the field determined. For example, the computing system 110 may look up the condition of the portion of the field within a table then identify the desired agricultural product(s) (e.g., type(s), mixture(s), concentration(s), etc.) associated with the condition of the portion of the field within the table.

Additionally, at (310), the method 300 may include performing a control action associated with the agricultural applicator when the agricultural product within the agricultural product tank is inadequate for the desired agricultural product. For example, the computing system 110 may perform a control action associated with the agricultural applicator (e.g., sprayer 10) when the agricultural product within the agricultural product tank(s) 36 on the agricultural applicator is inadequate for the desired agricultural product. Particularly, the computing system 110 may perform a control action associated with the agricultural applicator (e.g., sprayer 10) when the agricultural product within the agricultural product tank(s) 36 on the agricultural applicator is not the desired agricultural product and/or the injection system 43 cannot be controlled to provide the desired agricultural product from the products within the product tank(s) 36 on the agricultural applicator. For instance, the control action may include one or more of notifying an operator associated with the agricultural applicator that the agricultural product within the agricultural product tank(s) 36 on the agricultural applicator (e.g., sprayer 10) is inadequate for (direct application and/or injection by the injection system 43) the desired agricultural product, recommending to the operator that a changeover procedure occur, and/or implementing the changeover procedure.

It is to be understood that the steps of the method 300 are performed by the computing system 110 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 110 described herein, such as the method 300, is implemented in software code or instructions which are tangibly stored on a tangible computer readable medium. The computing system 110 loads the software code or instructions via a direct interface with the computer readable medium or via a wired and/or wireless network. Upon loading and executing such software code or instructions by the computing system 110, the computing system 110 may perform any of the functionality of the computing system 110 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for monitoring agricultural application operations, the system comprising:
an agricultural applicator comprising a frame, an agricultural product tank supported on the frame, and at least one dispensing assembly fluidly couplable to the agricultural product tank, the agricultural applicator being configured to dispense an agricultural product from the agricultural product tank via the at least one dispensing assembly as the agricultural applicator moves across a field during an agricultural application operation;
at least one sensor having a field of view directed towards a portion of the field, the at least one sensor being configured to generate data indicative of a condition of the portion of the field; and
a computing system configured to:
receive an input indicative of the agricultural product within the agricultural product tank on the agricultural applicator;
receive the data generated by the at least one sensor;
determine the condition of the portion of the field based at least in part on the data generated by the at least one sensor;
determine a desired agricultural product to dispense from the agricultural applicator based at least in part on the condition of the portion of the field; and
perform a control action associated with the agricultural applicator when the agricultural product within the agricultural product tank is inadequate for the desired agricultural product.

2. The system of claim 1, further comprising a tendering system separate of the agricultural applicator, the tendering system having at least one tendering tank,
wherein the computing system is configured to perform the control action by controlling the tendering system to fill the agricultural product tank on the agricultural applicator with the desired agricultural product.

3. The system of claim 2, wherein at least one of the agricultural applicator or the tendering system further comprises one or more receiving tanks,
wherein the computing system is further configured to perform the control action by instructing evacuation of the agricultural product from the agricultural product tank into the one or more receiving tanks before controlling the tendering system to fill the agricultural product tank with the desired agricultural product.

4. The system of claim 2, wherein at least one of the agricultural applicator or the tendering system includes a cleaning fluid tank configured to hold a cleaning fluid,
wherein the computing system is further configured to perform the control action by instructing supply of the cleaning fluid through the agricultural product tank before controlling the tendering system to fill the agricultural product tank with the desired agricultural product.

5. The system of claim 2, wherein the computing system is further configured to automatically route the agricultural applicator to the tendering system.

6. The system of claim 2, wherein the computing system is further configured to perform the control action by:
controlling a user interface to request filling the agricultural product tank with the desired agricultural product; and
receiving an input via the user interface indicative of accepting the request before controlling the tendering system to fill the agricultural product tank on the agricultural applicator with the desired agricultural product.

7. The system of claim 1, wherein the computing system is configured to perform the control action by controlling a user interface to indicate that the agricultural product within the agricultural product tank is inadequate for the desired agricultural product.

8. The system of claim 1, wherein the computing system is configured to determine the desired agricultural product based at least in part on a table correlating different field conditions with different agricultural products, the condition of the portion of the field being associated with the desired agricultural product within the table.

9. The system of claim 1, wherein the condition of the portion of the field comprises at least one of a type of plant present within the portion of the field or moisture content within the portion of the field.

10. The system of claim 1, wherein the at least one sensor is supported on the agricultural applicator.

11. A method for monitoring an agricultural application operation by an agricultural applicator, the agricultural applicator being configured to dispense an agricultural product from an agricultural product tank via at least one dispensing assembly as the agricultural applicator moves across a field during the agricultural application operation, the method comprising:
receiving, with a computing system, data indicative of the agricultural product within the agricultural product tank of the agricultural applicator;
receiving, with the computing system, data generated by at least one sensor having a field of view directed towards a portion of the field, the data being indicative of a condition of the portion of the field;
determining, with the computing system, the condition of the portion of the field based at least in part on the data generated by the at least one sensor;
determining, with the computing system, a desired agricultural product to dispense from the agricultural applicator based at least in part on the condition of the portion of the field; and
performing, with the computing system, a control action associated with the agricultural applicator when the agricultural product within the agricultural product tank is inadequate for the desired agricultural product.

12. The method of claim 11, wherein performing the control action comprises controlling a tendering system to fill the agricultural product tank on the agricultural applicator with the desired agricultural product, the tendering system being separate of the agricultural applicator.

13. The method of claim 12, wherein performing the control action further comprises instructing evacuation of the agricultural product from the agricultural product tank into one or more receiving tanks before the tendering system fills the agricultural product tank with the desired agricultural product, the one or more receiving tanks being part of at least one of the agricultural applicator or the tendering system.

14. The method of claim 12, wherein performing the control action further comprises instructing supply of cleaning fluid from a cleaning fluid tank of at least one of the agricultural applicator or the tendering system through the agricultural product tank before the tendering system fills the agricultural product tank with the desired agricultural product.

15. The method of claim 12, wherein performing the control action further comprises automatically routing the agricultural applicator to the tendering system.

16. The method of claim 11, wherein determining the desired agricultural product comprises determining the desired agricultural product based at least in part on a table correlating different field conditions with different agricultural products, the condition of the portion of the field being associated with the desired agricultural product within the table.

17. The method of claim 11, wherein performing the control action comprises controlling a user interface to indicate that the agricultural product within the agricultural product tank is inadequate for the desired agricultural product.

18. The method of claim 11, wherein determining the condition of the portion of the field comprises determining at least one of a type of plant present within the portion of the field or moisture content within the portion of the field.

19. The method of claim 11, wherein receiving the data generated by the at least one sensor comprises receiving the data generated by the at least one sensor supported on the agricultural applicator.

20. The method of claim 11, further comprising controlling, with the computing system, the at least one dispensing assembly of the agricultural applicator to dispense the agricultural product within the portion of the field when the agricultural product within the agricultural product tank corresponds to the desired agricultural product.
